(19) United States
(12) Patent Application Publication
(10) Pub. No.: US 2002/0096514 A1
(43) Pub. Date: Jul. 25, 2002

(54) Heat retaining microwavable dish

(76) Inventors: Jerry Johnson, Pittsburgh, PA (US); Terry Johnson, Pittsburgh, PA (US)

Correspondence Address: JAMES RAY & ASSOCIATES, 2640 Pitcairn Road, Monroeville, PA, 15146, US

(21) Appl. No.: 09/767,182

(22) Filed: Jan. 22, 2001

(51) Int. Cl. H05B 6/80

(52) U.S. Cl. 219/730; 219/759

(57) ABSTRACT

A microwavable heat retaining dish is provided. This heat retaining dish includes a dish shaped member and heat retaining component cooperating with the dish shaped member. The heat retaining component is capable of being heated by microwave radiation in order to maintain any food placed on the dish at an elevated temperature. The heat retaining component includes a heat retaining medium therein. The heat retaining component is capable of accommodating for expansion of this heat retaining medium during heating of the dish. The heat retaining component further includes a reclosable filling spout which allows for replacement of the heat retaining medium.

### FIELD OF THE INVENTION

The present invention is directed to a microwavable dish and more particularly to a microwavable heat retaining dish for keeping food warm.

### DESCRIPTION OF RELATED ART

A microwave oven is an appliance that uses electromagnetic energy to heat and cook foods. A microwave uses microwaves, very short radio waves commonly employed in radar and satellite communications. When concentrated within a small space, these waves efficiently heat water and other substances within foods.

Microwaves cook food rapidly and efficiently because, unlike conventional ovens, they heat only the food and not the air or the oven walls. The heat spreads within food by conduction.

Microwaves pass through many types of glass, paper, ceramics, and plastics, making many containers composed of these materials good for holding food. Various types of microwavable dishes are currently available in the marketplace. One drawback to these types of dishes is that they do not retain heat and thus a relatively larger thermal gradient exists between the heated food and the dish. Therefore, upon removal of the heated food from the microwave, the heat quickly dissipates from the food and transfers to the container causing the food to become cold.

U.S. Pat. No. 4,143,647 to Husslein et al seeks to overcome the above-mentioned drawback by producing a microwavable dish wherein a portion of the dish which surrounds the food is formed from a material having high-frequency radiation absorption characteristics. This enables the area surrounding the food to be heated by the high-frequency radiation to such an extent that there is no, or only a small, thermal gradient between the heated food and the dish material which prevents the food from rapidly cooling down.

One disadvantage of forming the microwavable dish from a high-frequency radiation absorbing material is that the dish can become very hot and become a hazard to the person handling the dish. For this reason, Husslein et al teaches that the handles of the dish must be made from a low-frequency radiation-absorbing material. However, the use of multiple materials to form the dish can become costly to produce and economically undesirable to manufacture.

U.S. Pat. No. 5,052,369 to Johnson teaches a heat retaining food container having a cover and a bottom portion, each one of the cover and bottom portion includes a heat storage system comprised of a non-metallic heat storing mass enclosed within a sealed chamber. The walls forming the chamber are formed from a polymeric material which is transparent to microwave radiation, heat stable up to approximately 400° F., chemically stable to detergents and rinsing agents, and resistant to staining. The container may be safely heated in conventional oven or a microwave. A dish holding hot food may be placed within the heated food container in order to keep the food warm.

A disadvantage of the heat retaining container taught by Johnson is that neither the cover nor the bottom portion include a means of escape for any gases that may be generated during heating of the container. Neither does the container include a sufficiently sized opening which contains the wax which would compensate for any expansion of the wax which may occur during heating. As a result, the container may become cracked or deformed during heating.

### OBJECTIVES OF THE INVENTION

It is therefore an objective of the invention to produce a microwavable heat retaining dish for keeping food warm.

A further objective is to produce a microwavable heat retaining dish capable of withstanding the effects of microwave radiation without cracking or warping.

Another objective is to produce a microwavable heat retaining dish capable of steam heating the food in order to keep food moist and warm.

A further objective is to produce a microwavable heat retaining dish wherein the heat retaining means may be readily replenished.

Another objective is to produce a microwavable heat retaining dish in an economical manner.

A still further objective is to produce a microwavable heat retaining dish having aesthetic appeal.

In addition to the objectives and advantages listed above, various other objectives and advantages of the invention will become more readily apparent to persons skilled in the relevant art from a reading of the detailed description section of this document. The other objectives and advantages will become particularly apparent when the detailed description is considered along with the drawings and claims presented herein.

### SUMMARY OF THE INVENTION

Briefly, and in accordance with the forgoing objectives, the invention comprises a microwavable heat retaining dish having a dish shaped member and heat retaining means cooperating with the dish shaped member. The heat retaining means is capable of being heated by microwave radiation in order to maintain any food placed on the dish at an elevated temperature. The heat retaining means includes a heat retaining medium therein, as well as, a means for accommodating for expansion of this heat retaining medium during heating of the dish. The heat retaining means further includes a reclosable filling spout which allows for replacement of the heat retaining medium.

### BRIEF DESCRIPTION OF THE DRAWINGS

FIG. 1 shows an expanded side view of a microwavable heat retaining dish according to a first embodiment of the invention.

FIGS. 1A, 1B and 1C show top views of the separate components of the microwavable heat retaining dish of FIG. 1.

FIGS. 1D, 1E and 1F show side views of the separate components of the microwavable heat retaining dish of FIG. 1.

FIG. 2 shows an expanded side view of a microwavable heat retaining dish according to a second embodiment of the invention.

FIGS. 2A, 2B and 2C show perspective views of the separate components of the microwavable heat retaining dish of FIG. 2.

FIG. 3 shows a side view of a microwavable heat retaining dish according to a third embodiment of the invention.

FIGS. 3A and 3B show side views of the separate components of the microwavable heat retaining dish of FIG. 3.

FIG. 4 shows a side view of a microwavable heat retaining dish according to a fourth embodiment of the invention.

FIGS. 4A and 4B show side views of the separate components of the microwavable heat retaining dish of FIG. 4.

FIG. 5 shows a side view of a microwavable heat retaining dish according to a fifth embodiment.

FIG. 6 shows a side view of a microwavable heat retaining dish according to a sixth embodiment of the invention.

### DETAILED DESCRIPTION OF THE DRAWINGS

Before describing the invention in detail, the reader is advised that, for the sake of clarity and understanding, identical components having identical functions have been marked where possible with the same reference numerals in each of the Figures provided in this document.

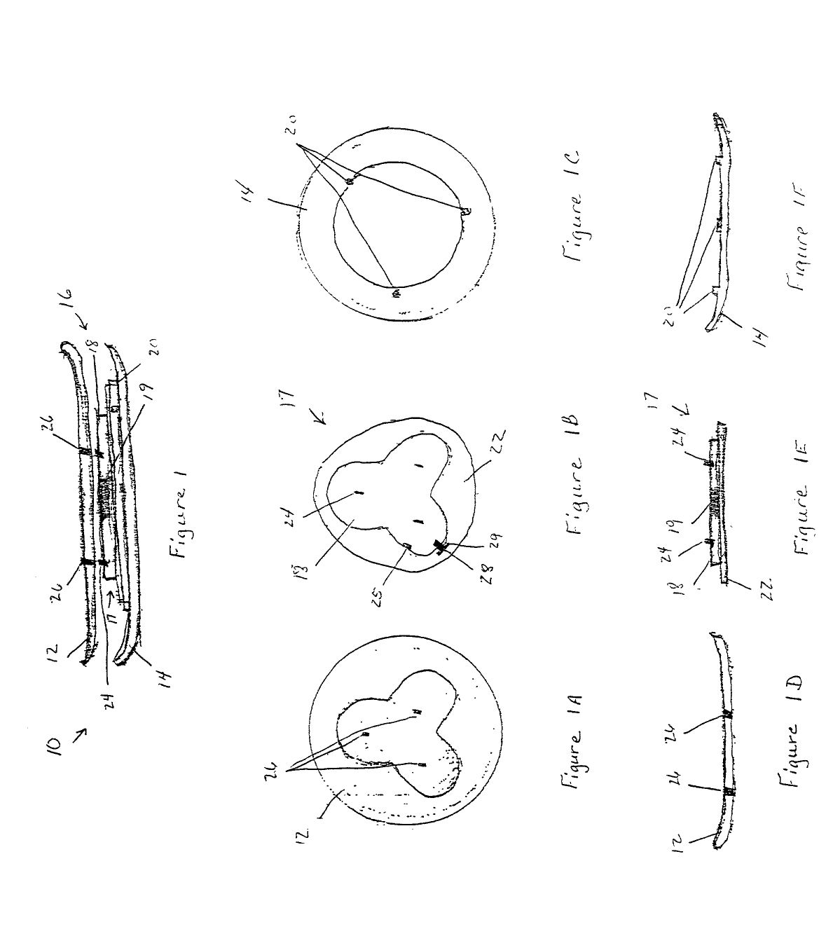

Referring now to FIGS. 1 and 1A-1F, there is shown a microwavable heat retaining dish, generally indicated as 10, according to a first embodiment of the invention. This microwavable heat retaining dish comprises a dish shaped member having a top member 12, a bottom member 14 extending substantially along a bottom surface of the top member 14 and secured thereto by any well known means. This well known means can include mechanical securing means, adhesive, polymeric welding, and the like. At least one opening, generally indicated as 16, is formed between the top and bottom members 12, 14.

A heat retaining means, generally designated as 17, is provided. The heat retaining means 17 is capable of cooperating with the dish shaped member to form the microwavable heat retaining dish 10. This heat retaining means 17 is capable of being heated by microwave radiation and assisting in maintaining any food placed on the dish at an elevated temperature. Protrusions 20 may be provided on the bottom member 14 to aid in placement of the heat retaining means within the opening 16.

The heat retaining means 17 comprises an enclosing member 18 and a heat retaining medium 19 located within the enclosing member 18. The heat retaining means 17 may optionally include a handling portion 22 extending around at least a portion of an outer portion of the enclosing member 18. This handling portion 22 is made from a material which does not readily absorb microwave radiation and thus remains cool to the touch after heating of the heat retaining means 17.

The enclosing member 18 is formed from any well known material which is substantially transparent to microwave radiation. Such material can include glass, a polymeric material such as polyetherimide resin, or any other well known material suitable for use within a microwave. For aesthetic purposes, this material may include a color. In the embodiment shown in FIG. 1, it also will be necessary to form the top member 14 from a material substantially transparent to microwave radiation.

The enclosing member 18 may also include a vent 25 for allowing any entrapped gases to escape therefrom. Alternatively, the enclosing member 18 may have a predetermined size which allows for expansion of the heat retaining medium 19 during heating.

The heat retaining medium 19 may comprise any well known material capable of being heated by microwave radiation and for retaining the heat therein. This material can include wax, water, and the like.

If water is used as the heat retaining medium 19, a plurality of holes 24 may be provided which extend through the enclosing member 18. Corresponding holes 26 may be provided in the top member 12 to allow steam to escape from the heat retaining means 17 and through the food to assist in maintaining the food at the elevated temperature.

A reclosable filling spout 28 and a cap 29 may be provided in the enclosing member 18 for refilling this enclosing member with the heat retaining medium 19. Additionally, the heat retaining medium 19 can be provided with a color formed from an edible coloring means, e.g. food coloring and the like, to increase the aesthetic appeal of the dish.

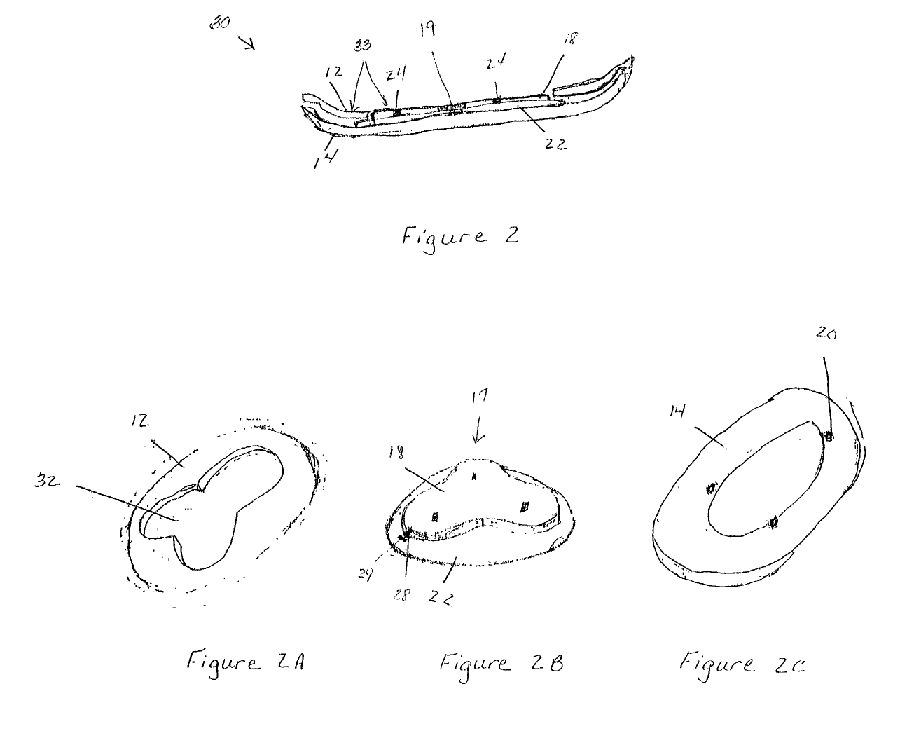

Referring now to FIGS. 2 and 2A-2C, there is shown a microwavable heat retaining dish, generally indicated as 30, according to a second embodiment of the invention. This embodiment differs from the first embodiment in that the top member 12 includes an aperture 32 extending through a center portion of the top member 12. The heat retaining means 17, particularly the enclosing member 18, has a predetermined shape capable of fitting within the aperture 32 in the top member 12 so as to form a food receiving surface 33.

A bottom member 14 is provided which extends substantially along a bottom surface of the top member 12 and is secured thereto by any well known means so as to assist in holding the heat retaining means 17 within the microwavable dish 30.

As in embodiment 1, a plurality of openings 24 may be provided for allowing steam to escape from the enclosing member 18. A reclosable filling spout 28 with a cap 29 may also be provided to enable additional medium 19 to be added into the enclosing member 18.

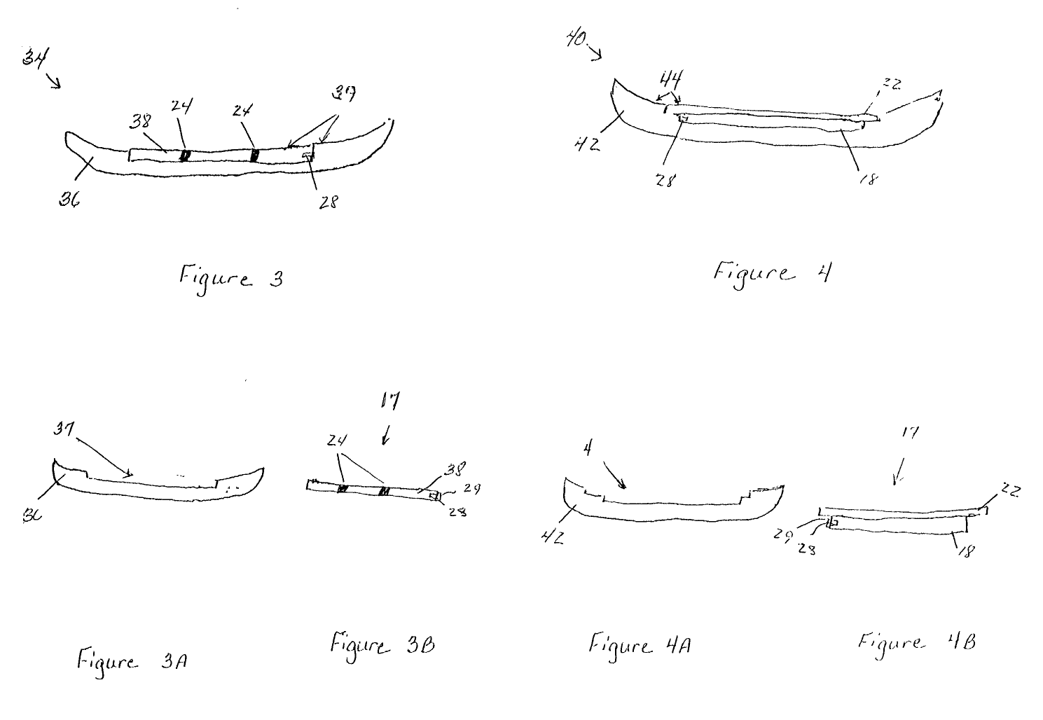

Now referring to FIGS. 3 and 3A-3B there is shown a microwavable heat retaining dish, generally indicated as 34, according to a third embodiment of the invention. This embodiment differs from the second embodiment in that the dish shaped member has a bottom member 36 which has a cut-out portion 37 in a top surface thereof. The heat retaining means 38 has a predetermined shape capable of fitting within the cut-out portion 37 in the dish shaped member so as to form a food receiving surface 39.

A plurality of openings 24 may also be provided in the enclosing member 38 of this third embodiment for allowing steam to escape therefrom. A reclosable filling spout 28 with a cap 29 may also be provided to enable additional heat retaining medium 19 to be added into the enclosing member 38.

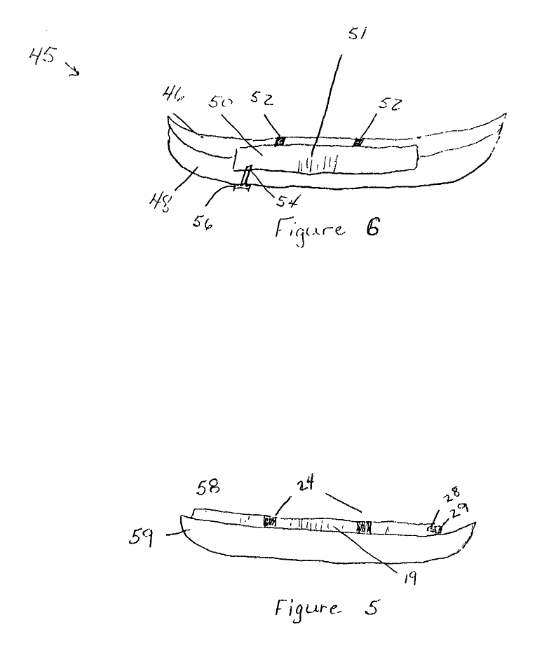

Now referring to FIGS. 4 and 4A-4B, there is shown a microwavable heat retaining dish, generally indicated as 40, according to a fourth embodiment of the invention. This embodiment differs from the third embodiment in that the heat retaining means 17 includes the handling portion 22 extending about the outer surface of at least a portion of the enclosing member 18. The dish shaped member has a bottom member 42 which has a cut-out portion 43 in a top surface thereof which corresponds to the enclosing member 18 and the handling portion 22 of the heat retaining member 17. The heat retaining member 17 is placed within the cut out portion 43 of the bottom member 42 in such a manner that the handling portion 22 cooperates with a top portion of the bottom member 42 to form a food receiving surface 44.

As in the first three embodiments, a reclosable filling spout 28 with a cap 29 may also be provided to enable additional heat retaining medium 19 to be added into the enclosing member 18. Also, the enclosing member 18 is of a sufficient size to accommodate any expansion of the heat retaining medium 19 during heating.

Embodiments 1-4 all show the heat retaining means as a component of the dish. However, FIG. 5 shows an embodiment wherein the heat retaining means 58 is a separate entity from the dish 59. In this embodiment, the heat retaining means 58 may be separately heated in the microwave and then placed onto the dish 59. The food can then be placed on this heated heat retaining means 58. This embodiment would allow one to use any shaped dish which is capable of receiving the heat retaining means 58 thereon. As in the above mentioned embodiments, a plurality of openings 24 may be provided for allowing steam to escape from the heat retaining means 58. A reclosable filling spout 28 with a cap 29 may also be provided to enable additional medium 19 to be added into the heat retaining means 58. Also, a handling portion, not shown, may be provided for handling the heated heat retaining means 58.

Now referring to FIG. 6, there is shown a microwavable heat retaining dish, generally indicated as 45, according to a sixth embodiment. This embodiment differs from the other embodiments in that the heat retaining means is not a separate member. Rather, an opening 50 is formed between a top member 46 and a bottom member 48. This opening 50 functions as the enclosing member and the heat retaining medium 51 is placed directly in this opening.

The top member 46 is formed from any well known material which is substantially transparent to microwave radiation. The heat retaining medium may comprise any well known material as discussed above. The opening 50 may have a predetermined size which allows for expansion of the heat retaining medium during heating. Preferably this heat retaining medium comprises water and the top member 46 includes a plurality of holes 52 extending therethrough to allow steam to escape from the opening and through the food to assist in maintaining the food at an elevated temperature.

Also, either the top member 46 or the bottom member 48 may include a reclosable filling spout 54, with a cap 56, for refilling the opening with the heat retaining medium 51.

Six examples have thus far been disclosed for a microwavable heat retaining dish. Nevertheless, a variety of modifications to the microwavable dish may be gleaned through experimentation and optimization of the subject matter disclosed herein.

The invention has been described in such full, clear, concise and exact terms so as to enable any person skilled in the art to which it pertains to make and use the same. It should be understood that variations, modifications, equivalents and substitutions for components of the specifically described embodiments of the invention may be made by those skilled in the art without departing from the spirit and scope of the invention as set forth in the appended claims. Persons who possess such skill will also recognize that the foregoing description is merely illustrative and not intended to limit any of the ensuing claims to any particular narrow interpretation.

We claim:

1. A microwavable heat retaining dish comprising:
(a) a dish shaped member; and
(b) a heat retaining means cooperating with said dish shaped member, said heat retaining means being capable of being heated by microwave radiation in order to maintain any food placed on said dish at an elevated temperature.

2. A microwavable heat retaining dish as recited in claim 1 wherein said heat retaining means comprises an enclosing member and a heat retaining medium located within said enclosing member.

3. A microwavable heat retaining dish as recited in claim 2 wherein said heat retaining means include a handling portion extending around at least a portion of an outer portion of said enclosing member.

4. A microwavable heat retaining dish as recited in claim 2 wherein said enclosing member is formed from a material substantially transparent to microwave radiation.

5. A microwavable heat retaining dish as recited in claim 2 wherein said enclosing member includes a vent for allowing any entrapped gases to escape therefrom.

6. A microwavable heat retaining dish as recited in claim 2 wherein said enclosing member has a predetermined size which allows for expansion of said heat retaining medium during heating.

7. A microwavable heat retaining dish as recited in claim 2 wherein said heat retaining medium comprises wax.

8. A microwavable heat retaining dish as recited in claim 2 wherein said heat retaining medium comprises water.

9. A microwavable heat retaining dish as recited in claim 7 wherein said enclosing member includes a plurality of holes extending therethrough to allow steam to escape from said heat retaining means and through said food to assist in maintaining said food at said elevated temperature.

10. A microwavable heat retaining dish as recited in claim 2 further including a reclosable filling spout for refilling said enclosing member with said heat retaining medium.

11. A microwavable heat retaining dish as recited in claim 2 wherein one of said heat retaining medium includes an edible coloring material and said enclosing member is formed from a colored material to increase the aesthetic appeal of said dish.

12. A microwavable heat retaining dish as recited in claim 2 wherein said dish shaped member comprises a top member, a bottom member extending substantially along a bottom surface of said top member and secured thereto, and at least one opening formed between said top and bottom members.

13. A microwavable heat retaining dish as recited in claim 12 wherein said enclosing member is placed within said opening for retaining said heat retaining medium.

14. A microwavable heat retaining dish as recited in claim 13 wherein said top member is formed from a material substantially transparent to microwave radiation.

15. A microwavable heat retaining dish as recited in claim 13 wherein said enclosing member and one of said top member and said bottom member include a vent for allowing any entrapped gases to escape from said opening.

16. A microwavable heat retaining dish as recited in claim 13 wherein said heat retaining medium comprises water and wherein said top member includes a plurality of holes extending therethrough to allow steam to escape from said opening and through said food to assist in maintaining said food at said elevated temperature.

17. A microwavable heat retaining dish as recited in claim 1 wherein said dish shaped member comprises a top member having an aperture extending through a center portion of said top member and said heat retaining means has a predetermined shape capable of fitting within said aperture in said top member so as to form a food receiving surface.

18. A microwavable heat retaining dish as recited in claim 17 wherein said dish shaped member further includes a bottom member extending substantially along a bottom surface of said top member and secured thereto so as to assist in holding said heat retaining means within said microwavable dish.

19. A microwavable heat retaining dish as recited in claim 1 wherein said dish shaped member has a cut-out portion in a top surface thereof and said heat retaining means has a predetermined shape capable of fitting within said cut-out portion in said dish shaped member so as to form a food receiving surface.

20. A microwavable heat retaining dish as recited in claim 12 wherein said opening forms said enclosing member for retaining said heat retaining medium.

21. A microwavable heat retaining dish as recited in claim 20 wherein said top member is formed from a material substantially transparent to microwave radiation.

22. A microwavable heat retaining dish as recited in claim 20 wherein said heat retaining medium comprises water and wherein said top member includes a plurality of holes extending therethrough to allow steam to escape from said opening and through said food to assist in maintaining said food at said elevated temperature.

23. A microwavable heat retaining dish as recited in claim 20 further including a reclosable filling spout in one of said top and bottom members for refilling said opening with said heat retaining medium.

24. A microwavable heat retaining dish as recited in claim 20 wherein said opening has a predetermined size which allows for expansion of said heat retaining medium during heating.
